(19) United States
(12) Patent Application Publication
(10) Pub. No.: US 2015/0279354 A1
(43) Pub. Date: Oct. 1, 2015

(54) Personalization and Latency Reduction for Voice-Activated Commands

(71) Applicants: Alexander Gruenstein, Mountain View, CA (US); William J. Byrne, Davis, CA (US)

(72) Inventors: Alexander Gruenstein, Mountain View, CA (US); William J. Byrne, Davis, CA (US)

(73) Assignee: Google Inc., Mountain View, CA (US)

(21) Appl. No.: 13/250,038

(22) Filed: Sep. 30, 2011

Related U.S. Application Data
(63) Continuation of application No. 12/783,470, filed on May 19, 2010, now abandoned.

(51) Int. Cl. G10L 15/08; G10L 17/22; G10L 15/26

(52) U.S. Cl. CPC G10L 15/08; G10L 15/26; G10L 17/22

(57) ABSTRACT

An apparatus to personalize voice recognition on a client device includes a microphone, an embedded speech recognizer, a tag comparator, a client query manager, a user interface and a tag generator. An embedded speech recognizer receives an audio input from a user and generates recognition candidates, selecting one recognition candidate from the generated candidates. A tag comparator compares the audio stream with a first stored audio tag. The client query manager receives the selected recognition candidate and if the tag comparator matches the audio stream with the first audio tag then the client query manager executes an associated query. If no tag match is found, then the client query manager executes a query using the selected recognition candidate. After an indication from the user of a selected result, a tag generator stores a second audio tag in the storage based on the selected recognition candidate and the selected result.

### CROSS REFERENCE TO RELATED APPLICATIONS

This patent application claims the benefit of U.S. patent application Ser. No. 12/783,470 filed on May 19, 2010, entitled “Personalization and Latency Reduction for Voice-Activated Commands,” which is incorporated by reference herein in its entirety.

### FIELD

The present application generally relates to voice activated application function and speech recognition.

### BACKGROUND

Speech recognition systems in mobile devices allow users to communicate and provide commands to a mobile device with minimal usage of input controls such as, for example, keypads, buttons, and dials. Some speech recognition tasks can be a complex process for mobile devices, requiring an extensive analysis of speech signals and search of word and language statistical models.

Users often say the same query multiple times (e.g., they are often interested in the same sports team, movie, etc). If the speech recognizer makes an error the first time the user performs the search, it will likely make the same error for subsequent searches. Under a traditional approach, subsequent searches for an item are no faster Than a first search. This repeated action can be even more significant if the speech-recognizing functions are divided between the mobile device and a remote recognizer.

Repeated errors can lead to a poor user experience, especially if a user has taken steps to correct the error during a previous instance. Methods and systems are needed for improving the user experience with respect to repeated voice searches.

### BRIEF SUMMARY

Embodiments described herein relate to providing systems and methods for providing personalization and latency reduction for voice activated commands. According to an embodiment, an apparatus to personalize voice recognition on a client device includes a microphone, an embedded speech recognizer, a tag comparator, a client query manager, a user interface and a tag generator. The microphone is receives an audio input from a user and outputs a corresponding audio stream to an embedded speech recognizer which generates at least one recognition candidate and selects one recognition candidate from the generated candidates. A tag comparator compares the audio stream with a first stored audio tag. The client query manager receives the selected recognition candidate and if the tag comparator matches the audio stream with the first audio tag then the client query manager executes a query based on the stored tag. If the tag comparator does not match the audio stream with the first audio tag then the client query manager executes a query using the selected recognition candidate. A user interface receives and displays query results to the user, and receive an indication from the user of a selected result. Finally, a tag generator stores a second audio tag in the storage based on the selected recognition candidate and the selected result.

According to another embodiment, a method for performing a personalized voice command on a client device is provided. The method includes receiving a first audio stream from a user and creating, using a speech recognizer, a first translation of the first audio stream. The method further includes generating a list based on the translation of the first audio stream and receiving from the user, a selection from the list. Steps in the method generate a first speech tag based on the first audio stream and the selection and store the first speech tag. The method further includes receiving a second audio stream from the user and determining whether the second audio stream matches the first speech tag. If the second audio stream matches the first speech tag then the method includes creating, using the speech recognizer, a second translation of the second audio stream from the user, based on the first speech tag.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is an illustration of an exemplary communication system in which embodiments can be implemented.

FIG. 2 is an illustration of an embodiment of a client device.

FIGS. 3A-B and 4A-D are illustrations of a user interface on a mobile phone in accordance with embodiments.

FIGS. 5A-B illustrate a flowchart of a computer-implemented method of improving the user experience of an application according to an embodiment of the present invention.

FIG. 6 depicts a sample computer system that may be used to implement one embodiment.

### DETAILED DESCRIPTION OF EMBODIMENTS

The following detailed description refers to the accompanying drawings that illustrate exemplary embodiments. Embodiments described herein relate to providing systems and methods for providing personalization and latency reduction for voice activated commands. Other embodiments are possible, and modifications can be made to the embodiments within the spirit and scope of this description. Therefore, the detailed description is not meant to limit the embodiments described below.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

### Overview

As used herein, a “voice search” is a query submitted to a search engine whose terms have been generated by an audio stream of words generated by a human voice. Some embodiments described herein can increase the speed of satisfying search results, reduce user effort required to correct voice recognition and provide quick, accurate results without connectivity.

### Voice Search System 100

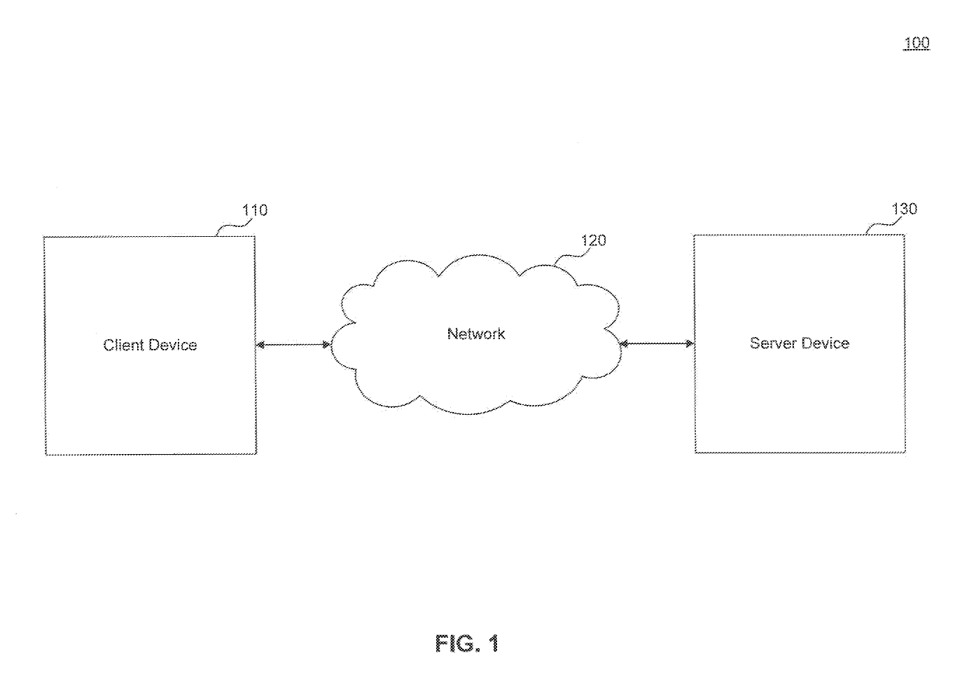

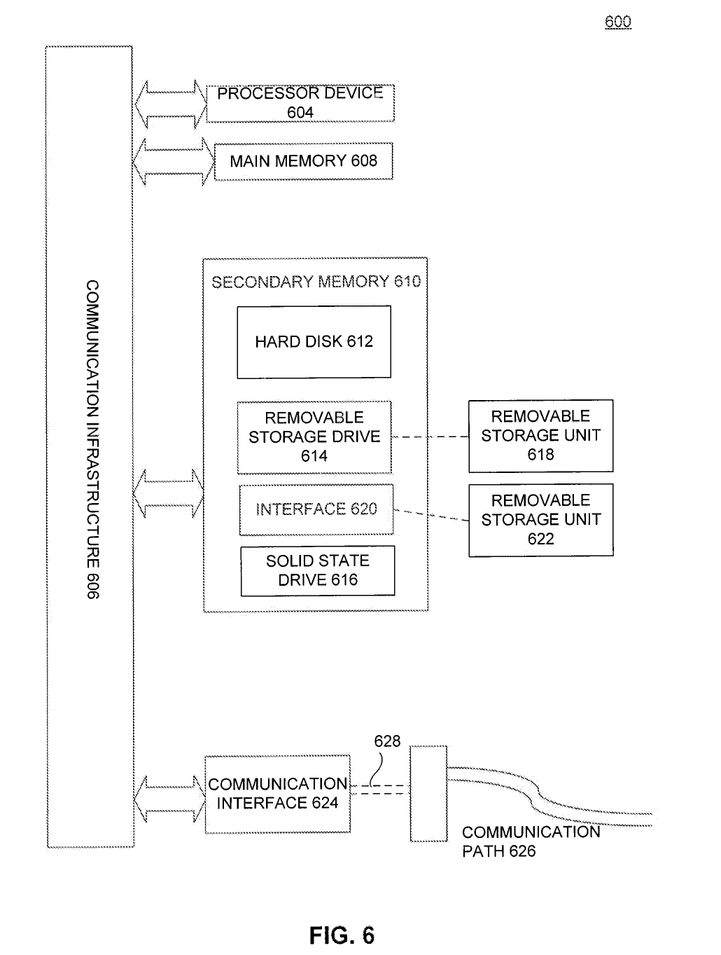

FIG. 1 shows a diagram illustrating system 100 for providing a personalized voice command on a client device. System 100 includes client device 110 that is communicatively coupled to server device 130 via network 120. Client device 110 can be, for example and without limitation, a mobile phone, a personal digital assistant (PDA), a laptop, a slate or “pad” PC, or other type of mobile devices. Server device 130 can be, for example and without limitation, a telecommunications server, a web server, or other similar types of network-connected server. In an embodiment, and as described further below with the description of FIG. 6, server device 130 can have multiple processors and multiple shared or separate memory components such as, for example and without limitation, one or more computing devices incorporated in a clustered computing environment or server farm. The computing process performed by the clustered computing environment, or server farm, may be carried out across multiple processors located at the same or different locations. In an embodiment, server device 130 can be implemented on a single computing device. Examples of computing devices include, but are not limited to, a central processing unit, an application-specific integrated circuit, or other type of computing device having at least one processor and memory. Further, network 120 can be any network or combination of networks, for example and without limitation, a local-area network, wide-area network, internet, a wired connection (e.g., Ethernet) or a wireless connection (e.g., Wi-Fi, 3G) network that communicatively couples client device 110 to server device 130.

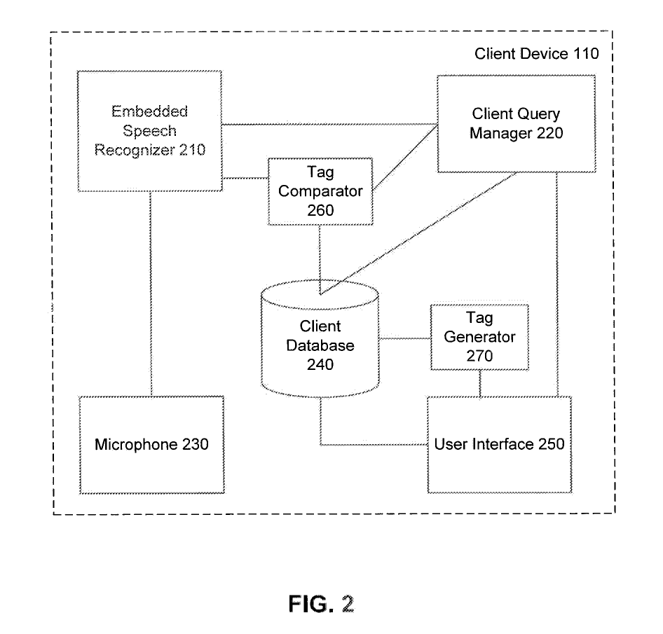

FIG. 2 is an illustration of an embodiment of client device 110. In an embodiment, client device 110 includes embedded speech recognizer 210, client query manager 220, microphone 230, client database 240, tag comparator 260, tag generator 270 and user interface 250. In an embodiment, microphone 230 is coupled to embedded speech recognizer 210, which is coupled to client query manager 220 and tag comparator 260, and client query manager 220 is coupled to client database 240 and user interface 250. In an embodiment, tag generator 270 is coupled to client database 240 and user interface 250, and tag comparator 260 is coupled to client database 240 and embedded speech recognizer 210.

In an embodiment, microphone 230 is configured to receive an audio stream corresponding to a voice command and to provide the audio stream to embedded speech recognizer 210. As used herein by some embodiments, a voice command can be, for example and without limitation, an indication by a user for an application operating on client device 110 to perform a particular function, e.g., “open email,” “increase volume” or other type of command. In another non-limiting example, in an embodiment, a voice command could also be an item of data provided by a user for the execution of a particular function, e.g., search terms (“movies in 22041”) or a navigation destination (“San Jose”). One having ordinary skill in the relevant arts given this description will conceive of further uses for voice input on client device 110.

The audio stream can be generated from an audio source such as, for example and without limitation, the speech of the user of client device 110, e.g., a person using a mobile phone, according to an embodiment. In turn, in an embodiment, embedded speech recognizer 210 is configured to translate the audio stream into a plurality of recognition candidates, as is known by a person of ordinary skill in the relevant art, each recognition candidate corresponding to the text of a potential voice command, and having a confidence value associated therewith, such confidence value measuring the estimated likelihood that a particular recognition candidate corresponds to the work that the user intended. For example and without limitation, if the audio stream sound corresponds to “dark-nite” recognition candidates could include “dark knight” and “dark night.” The user could have intended either candidate at the time of the steam, and each candidate can, in an embodiment, have an associated confidence value.

Network Based Speech Recognition

In an embodiment, embedded speech recognizer 210 is configured to provide the plurality of recognition candidates to client query manager 220, where this component is configured to select one recognition candidate. In an embodiment, the operation of the speech recognizer module can be termed, recognition, translation or other similar terms known in the art. In an embodiment, the selected recognition candidate corresponds to the candidate with the highest confidence value, though, as is discussed further herein, recognition candidates may be selected based on other factors.

Based on the selected recognition candidate, in an embodiment, client query manager 220 queries client database 240 to generate a query result. In an embodiment, client database 240 contains information that is locally stored in client device 110 such as, for example and without limitation, telephone numbers, address information, and results from previous voice commands, and “speech tags” (described in further detail below). In an embodiment, client database 240 can provide results even if no connectivity to network 120 is available.

In an embodiment, client query manager 220 also transmits data corresponding to the audio stream to server device 130 simultaneously, substantially the same time, or in a parallel manner as it queries client database 240. In an embodiment (not shown) microphone 230 bypasses embedded speech recognizer 210 and relays the audio stream directly to client query manager 220 for processing thereon.

An example of method and system to perform the integration of network and embedded speech recognizers can be found in U.S. patent application Ser. No. ______ (Atty. Docket No. 2525.2310000), which is entitled “Integration of Embedded and Network Speech Recognizers” and incorporated herein by reference in its entirety.

In an embodiment, the audio stream transmitted to server device 130 allows a remote server-based speech recognition system to also analyze and select additional recognition candidates. As with the process described above on the client device, in embodiments, the server-based speech recognition also selects a recognition candidate and performs a query using the selected candidate. In an embodiment, this process proceeds in parallel with the above-described processes on the client device, and once the results are available from the server, the results are sent and received by client device

As a result, in an embodiment, the query result from server device 130 can be received by client query manager 220 and displayed on display device 250 at substantially the same time as, in parallel with, or soon after the query result from client device 110. In the alternative, depending on the computation time for client query manager 220 to query client database 240 or the complexity of the voice command, the query result from server device 130 can be received by client query manager 220 and displayed on user interface 250 prior to the display of a query result from client database 240, according to an embodiment. As used below, the term “query results” can refer to either the results received from client database 240 or from server device 130.

Simultaneously, substantially the same time, or in a parallel manner the querying of both client database 240 and the server device 130 based speech recognition and querying described above, in an embodiment, client query manager 220 also provides the plurality of recognition candidates to user interface 250, where all or a portion of the plurality are displayed to the user.

Once displayed for the user as a list of recognition results, the user may select the recognition candidate that corresponds to their intended audio stream meaning. In an embodiment, the generated recognition candidates shown to the user for selection may be listed explicitly for the user, or a set of query results based on one or more of the candidates may be presented. For example and without limitation, as discussed above, if the user spoken phonetics correspond to “dark-nite,” the recognition candidates could include “dark night” and “Dark Knight,” wherein “dark night,” for example could have the highest confidence value of all the candidates.

In an embodiment, as described above, in parallel with this list of recognition candidates being displayed to the user, client database 240 is being queried for the candidate with the highest ranked confidence score—“dark night.” If “dark night” is the intention of the user, then no action need be taken, the results will be displayed for these query terms, either from client database 240 or from server device 130.

If, in this example, the user intended “dark knight,” (not the selected recognition candidate) the user could select this recognition candidate from the presented list, and in an embodiment, immediately interrupt and change the parallel queries being performed at both client database 240 and server device 130. The user would be presented with query results responsive to the query terms “dark knight” and would be able to select one result for further inquiry.

Personal Recognition Speech Tagging

In the example above, the audio streams for the recognition results associated with “dark night” and “dark knight” are likely to be identical or very similar for a user, e.g., if the same user spoke “dark night” and “dark knight,” the audio stream would likely be identical. In an embodiment, for future searches by the same user, a benefit may be realized in search precision and speed by preferring the pairings selected by the same user for past searches, e.g., if the user searches for “Dark Knight,” this particular recognition candidate should be preferred for future audio stream searches having the same phonetics. In am embodiment described below, this preference is enabled by preferring recognition candidates that already have a user defined speech recognition tag/linkage.

In an embodiment, a “speech recognition tag” (“speech tag” or “tag”) can be created and stored by client query manager 220 to store a user-defined/confirmed linkage between a particular audio stream and a particular recognition result, e.g., in the “dark-nite” example above, because a result that used the search term “Dark Knight” recognition result was selected by the user, a speech tag is a generated by tag generator 270 to link the particular stream characteristics with that result. The mechanics of generating this searchable speech tag would be known by one skilled in the relevant art.

In an embodiment, the linkage described above between an audio stream and a text equivalent can be expressed by a user when a recognition result is expressly selected from a list of other results, or when a query result is selected from a list of query results that was generated by the particular recognition result. One having ordinary skill in the art, and having access to the teachings herein, could design additional approaches to establishing pairs between audio streams and text equivalents.

In an embodiment, client query manager 220 stores the speech tag corresponding to a linkage between an audio stream and a selected recognition result in client database 240. In embodiments, not all of the described linkages between a user audio stream and a confirmed text equivalent are stored as audio tags. Different factors including, the user preference and the type of query may affect whether a speech tag associated with a linkage is stored in client database 240.

With generated speech tags stored on client device 110, in an embodiment, whenever a user performs a voice search, embedded speech recognizer 210 generates recognition candidates, as described above with the description of FIG. 2, and also, to provide personalization and resolve ambiguities in favor of past user selections, embedded speech recognizer 210 can use tag comparator 260 to compare the generated recognition candidates with speech tags stored in client database 240. In an embodiment, this comparison can influence the selection of a recognition candidate and thus have the benefits described above.

### Illustrative Example

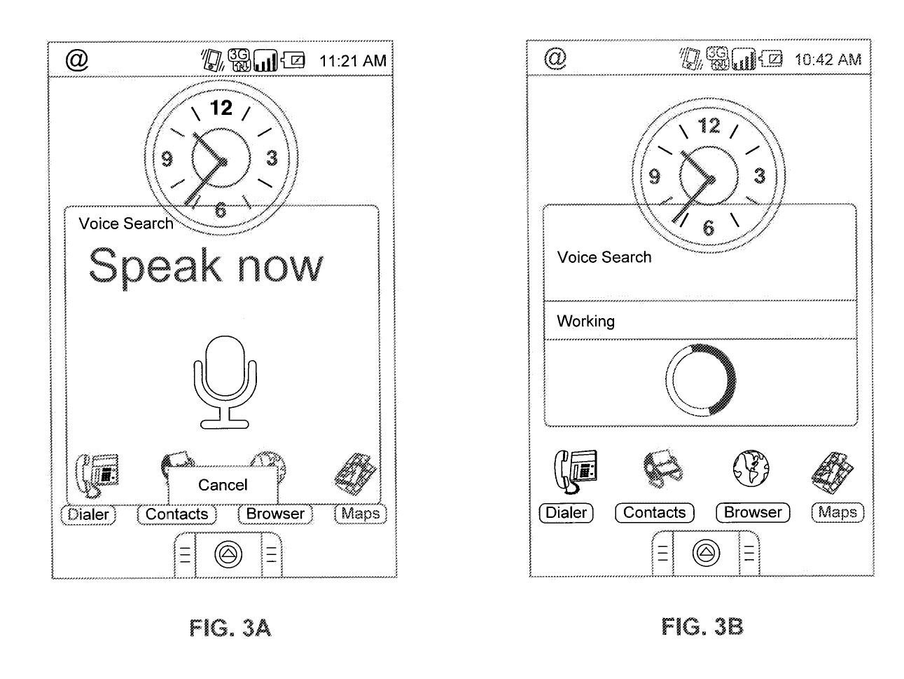

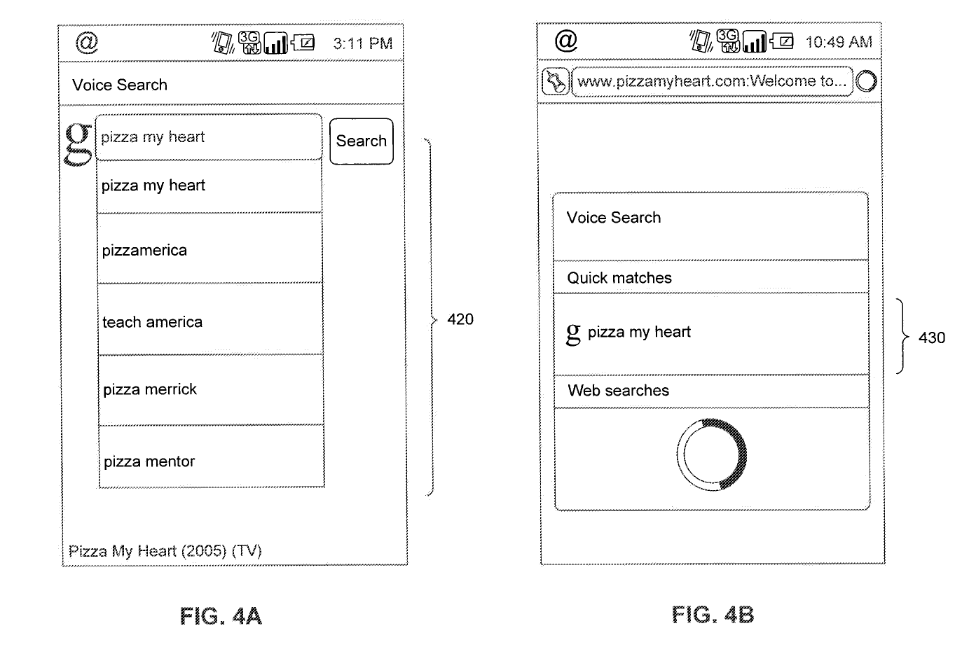

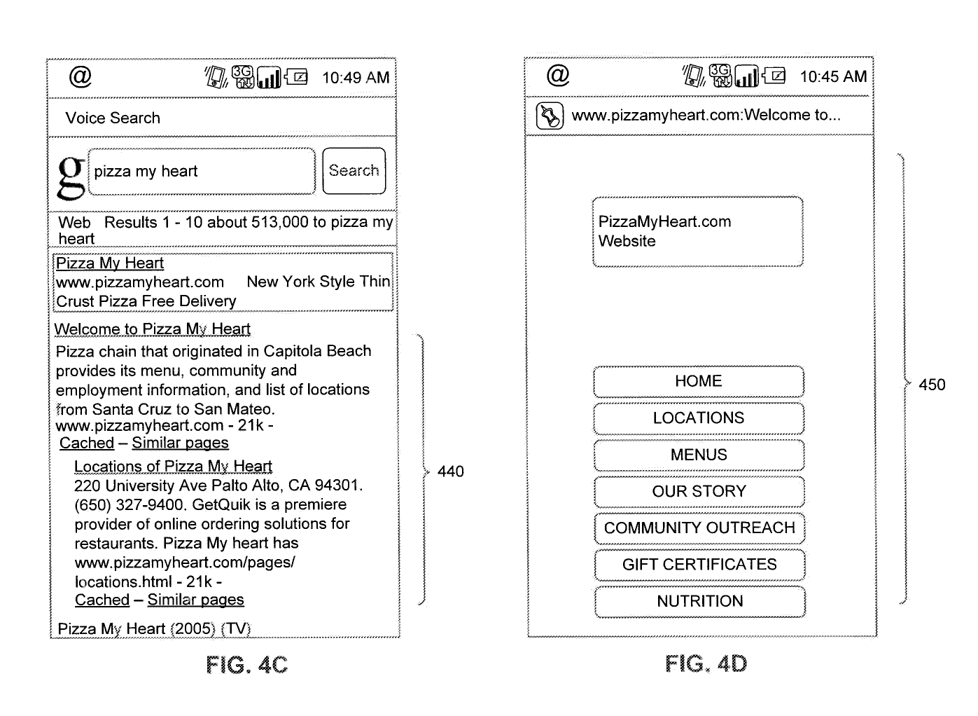

FIG. 3A depicts an embodiment of a user-interface screen from user interface 250 after a user has triggered an embodiment of an application on client device 110. The displayed prompt “speak now” is a prompt to the user to speak into the device. In this example, the user intends to search for their favorite pizza restaurant, “Pizza My Heart.” Upon the user speaking, microphone 230 captures an audio stream and relays the stream to embedded speech recognizer 210. In this example, once the user has finished speaking, the display screen of FIG. 3B can indicate that the application is proceeding.

Embedded speech recognizer 210 generates the list of recognition candidates, e.g., “pizzamerica,” “piece of my heart,” “pizza my heart” and these candidates are provided to tag comparator 260. In this example, tag comparator 260 compares these provided speech tags with the speech tags stored in client database 240.

In FIG. 4A in an embodiment based on the example above, user interface 250 presents a list of generated speech recognition candidates 420 and prompts the user to choose one. In one embodiment, these choices are recognition results generated by embedded speech recognizer 210, while in another embodiment, these are stored speech tags that have been chosen based on their similarity to the audio stream, and in an additional embodiment, these are speech recognition candidate results generated by a network-based speech recognizer. When a user selects a result, the chosen result is then used to perform a query, and as described above, in an embodiment, a speech tag is generated and stored linking the chosen result to the audio stream.

In FIG. 4B an example is depicted wherein one of the recognition candidates matches a stored speech tag for “Pizza My Heart.” In this embodiment, this match is termed a “quick match” and the result is labeled 430 as such for the user. A quick match is signaled to the user, and the user is invited to confirm the accuracy of this determination. Once the user confirms the quick-match, search results based on the quick-match are displayed. In another embodiment, if the user rejects the quick-match, or if a predetermined period of time elapses with no user input, then a different search is performed, e.g., a search based on a recognition candidate with the highest confidence value. One having ordinary skill in the art, and access to the teachings herein, could design various user interface approaches to use the above-described quick-match feature. In FIG. 4C an example is depicted wherein the search results 440 for the above-noted quick-match are immediately presented for the user without confirmation.

In FIG. 4D, according to an embodiment, instead of presenting a confirmation prompt or a list of query results, a single page 450 that corresponds to the top-rated search result can be displayed for the user. In another embodiment, the web site displayed is necessarily not the top ranked result, rather, is it the result that was previously selected by the user when the speech tag query was performed. FIG. 4D depicts the Pizza My Heart Restaurant web site, such site having been displayed for the user by an embodiment soon after the requesting words were spoken. As noted above, this rapid display of the results of a previous voice query is an example of a benefit that can be realized from an embodiment.

In an embodiment, the speech tag match event can be presented to the user via user interface 250, and confirmation of the selection can be requested from the user. In an embodiment, while user interface 250 is waiting for confirmation, the above-described searching based on a selected recognition candidate can be taking place. In an embodiment, after a predetermined period of time, the confirmation request to the user can be withdrawn and results from a different recognition candidate can be shown.

In an embodiment, the selection of any one of the above described approaches could be determined by a confidence level associated with the speech tag match. For example, if the user said an audio stream corresponding to “pizza my heart” and a high-confidence match was determined with the stored “Pizza My Heart” speech tag, then approach shown on FIG. 4D could be selected and no confirmation would be requested.

In should be noted that the above potential user interface 250 approaches described above in FIGS. 4A-D and accompanying description, are intended to be non-limiting. One having skill in the relevant art will appreciate that other user-interactions could be designed given the description of embodiments herein.

In an embodiment, the user is allowed to configure the speech tag approaches, FIGS. 4A-D, taken by the system. For example, the user may not want search tag matches to override results with high matching confidence. In another example, because search tags stored in client database 240, according to the processes described above, are specific to a particular user, a search application needs a method of overriding the search personalization for a different user.

### Other Example Applications

Embodiments are not limited to the search application described above. For example, a navigation application running on a mobile device, e.g., GOOGLE MAPS by Google Inc. of Mountainview, Calif., can use embodiments to improve user experience. Voice commands for map requests and directions can be analyzed and tags stored that match confirmed recognition profiles. In embodiments, direction results, such as a specific route from one place to another, can be stored in client database 240 and provided in response to a speech tag match—quick match—as described above.

In an embodiment, speech tags can have a significant value in quickly resolving frequently used place names for navigation. For example, a particular destination, e.g., address, city, landmark, may be frequently the subject of a navigation request by a user. As noted above, by resolving repeatedly used audio streams using speech tags, e.g., user destinations, some embodiments described herein can improve the user's experience. As would be appreciated by one having skill in the relevant art, embodiments described herein could have applications across different application types.

### Method

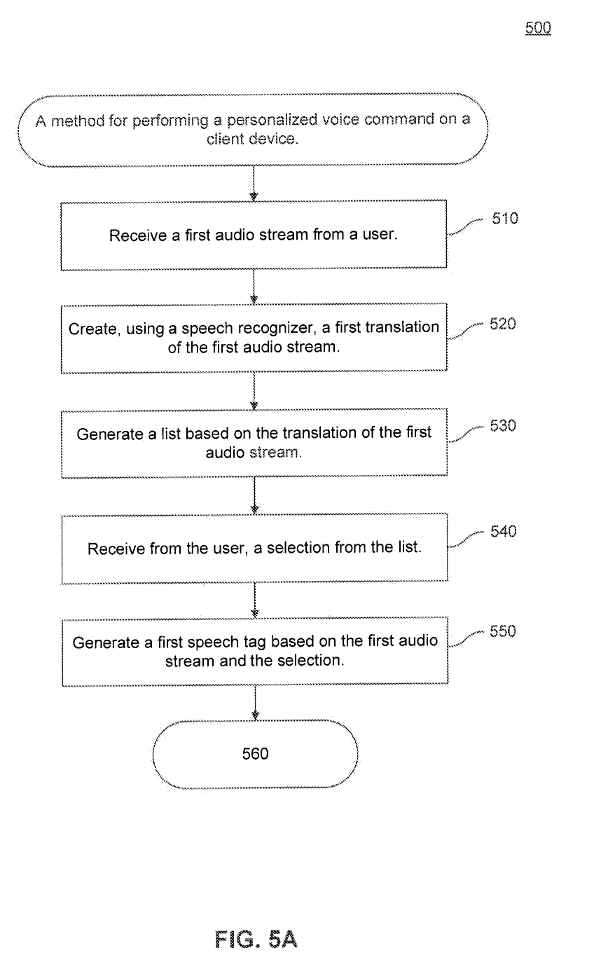

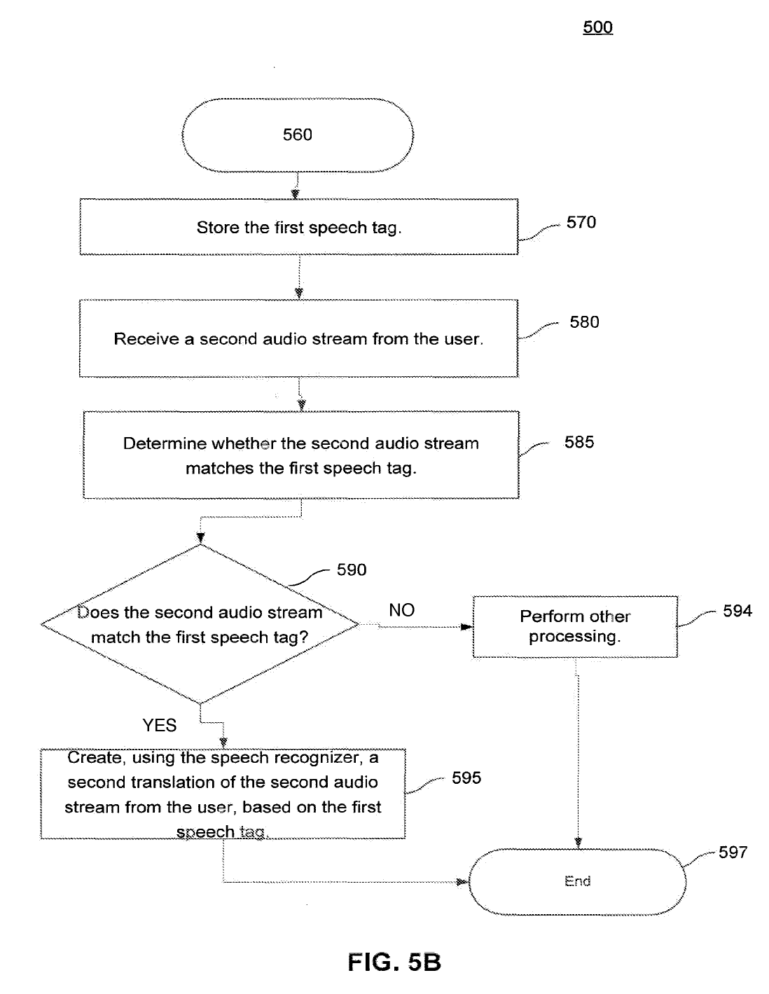

FIGS. 5A-B illustrates a more detailed view of how embodiments described herein may interact with other aspects of embodiments. In this example, a method for performing a personalized voice command on a client device is shown. Initially, as shown in stage 510 on FIG. 5A, a first audio stream is received from a user. At stage 520, a speech recognizer is used to create a first translation of the first audio stream. At stage 530, a list is generated based on the translation of the first audio stream, and at stage 540, a selection from the list is received from the user. At stage 550, a first speech tag based on the first audio stream and the selection is generated, and at stage 570 on FIG. 5B, the first speech tag is stored. At stage 580, a second audio stream is received from the user, and at stage 585, a determination is made as to whether the second audio stream matches the first speech tag. If, at stage 590, the second audio stream does match the first speech tag, then at stage 595, a second translation of a second audio stream is created using the speech recognizer, based on the speech tag. If the second audio stream does not match the first speech tag, then at stage 594 other processing is performed. After steps 594 or 595, the method operation ends.

### Example Computer System Implementation

FIG. 6 illustrates an example computer system 600 in which embodiments of the present invention, or portions thereof, may be implemented as computer-readable code. For example, system 100, FIGS. 1 and 2, and carrying out stages of method 500 of FIGS. 5A-B may be implemented in computer system 600 using hardware, software, firmware, tangible computer readable media having instructions stored thereon, or a combination thereof and may be implemented in one or more computer systems or other processing systems. Hardware, software or any combination of such may embody any of the modules/components in FIGS. 1 and 2 and any stage in FIGS. 5A-B.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 606, for example, a bus, message queue, network or multi-core message-passing scheme.

Computer system 600 also includes a main memory 608, for example, random access memory (RAM), and may also include a secondary memory 610. Secondary memory 610 may include, for example, a hard disk drive 612, removable storage drive 614 and solid state drive 616. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art, removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Computer program medium and computer usable medium may also refer to memories, such as main memory 608 and secondary memory 610, which may be memory semiconductors (e.g. DRAMs, etc.).

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the method illustrated by flowchart 500 of FIGS. 5A-B discussed above. Accordingly, such computer programs represent controllers of the computer system 600. Where the invention is implemented using software, the software may be stored in a computer program product and loaded into computer system 600 using removable storage drive 614, interface 620, hard disk drive 612 or communications interface 624.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

Embodiments described herein relate to systems and methods for providing personalization and latency reduction for voice activated commands. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

1. A computer-implemented method comprising:
receiving a first audio stream corresponding to a first voice command;
providing one or more candidate transcriptions of the first audio stream for output;
receiving data indicating (i) a selection of a particular candidate transcription of the first audio stream, or (ii) a selection of a result of a search query in which the particular candidate transcription of the first audio stream was used as a query term;
in response to receiving the data indicating (i) the selection of the particular candidate transcription, or (ii) the selection of the result of the search query in which the particular candidate transcription is used as a query term, storing data that pairs (i) the particular candidate transcription of the first audio stream, and (ii) the first audio stream;
after storing the data that pairs the particular candidate transcription of the first audio stream and the first audio stream, receiving a second audio stream corresponding to a second voice command;
comparing (i) a particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream;
based at least on comparing (i) the particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream, determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream; and
based at least on determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream, providing the particular candidate transcription of the second audio stream, or a result of a search query in which the particular candidate transcription of the second audio stream is used as a query term, for output.

2-34. (canceled)

35. The method of claim 1, wherein providing one or more candidate transcriptions of the first audio stream for output comprises:
obtaining one or more candidate transcriptions of the first audio stream that are generated by a speech recognizer implemented on a server.

36. The method of claim 1, wherein providing one or more candidate transcriptions of the first audio stream for output comprises:
obtaining one or more candidate transcriptions of the first audio stream that are generated by a speech recognizer implemented on a mobile device.

37. The method of claim 1, further comprising providing one or more other candidate transcriptions of the second audio stream for output after receiving data indicating a rejection of the particular candidate transcription of the second audio stream or after a predetermined amount of time elapses without receiving data indicating a confirmation of the particular candidate transcription of the second audio stream.

38. The method of claim 1, wherein providing the particular candidate transcription of the second audio stream, or a result of a search query in which the particular candidate transcription of the second audio stream is used as a query term, for output comprises presenting a confirmation control.

39. (canceled)

40. The method of claim 1, wherein providing the particular candidate transcription of the second audio stream, or a result of a search query in which the particular candidate transcription of the second audio stream is used as a query term, for output comprises providing a web site corresponding to a highest ranked search query result for output based on a search query performed using the particular candidate transcription of the second audio stream.

41. The method of claim 1, wherein providing the particular candidate transcription of the second audio stream, or a result of a search query in which the particular candidate transcription of the second audio stream is used as a query term, for output comprises providing a web site corresponding to a previously selected web site from a search query result based on a search query performed using the particular candidate transcription of the first audio stream.

42. The method of claim 1, wherein providing the particular candidate transcription of the second audio stream, or a result of a search query in which the particular candidate transcription of the second audio stream is used as a query term, for output comprises:
determining, based on a confidence level associated with the match between (i) the particular candidate transcription of the second audio stream and the particular candidate transcription of the first audio stream indicated in the stored data that pairs the particular candidate transcription of the first audio stream and the first audio stream, or (ii) the second audio stream and the first audio stream indicated in the stored data that pairs the particular candidate transcription of the first audio stream and the first audio stream, whether to display (i) a confirmation request, (ii) a list of search query results based on a search query performed using the particular candidate transcription of the second audio stream, (iii) a web site corresponding to a top-rated search query result based on a search query performed using the particular candidate transcription of the second audio stream, or (iv) a web site corresponding to a previously selected web site from a search query result based on a search query performed using the particular candidate transcription of the first audio stream.

43. A system comprising:
one or more computers and one or more storage devices storing instructions that are operable, when executed by the one or more computers, to cause the one or more computers to perform operations comprising:
receiving a first audio stream corresponding to a first voice command;
providing one or more candidate transcriptions of the first audio stream for output;
receiving data indicating a selection of a particular candidate transcription of the first audio stream;
in response to receiving the data indicating the selection of the particular candidate transcription of the first audio stream, storing data that pairs (i) the particular candidate transcription of the first audio stream, and (ii) the first audio stream;
after storing the data that pairs the particular candidate transcription of the first audio stream and the first audio stream, receiving a second audio stream corresponding to a second voice command;
comparing (i) a particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream;
based at least on comparing (i) the particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream, determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream; and
based at least on determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream, providing the particular candidate transcription of the second audio stream, or a result of a search query in which the particular candidate transcription of the second audio stream is used as a query term, for output.

44. The system of claim 43, wherein providing one or more candidate transcriptions of the first audio stream for output comprises:
obtaining one or more candidate transcriptions of the first audio stream that are generated by a speech recognizer implemented on a server.

45. The system of claim 43, wherein providing one or more candidate transcriptions of the first audio stream for output comprises:
obtaining one or more candidate transcriptions of the first audio stream that are generated by a speech recognizer implemented on a mobile device.

46. The system of claim 43, further comprising providing one or more other candidate transcriptions of the second audio stream for output after receiving data indicating a rejection of the particular candidate transcription of the second audio stream or after a predetermined amount of time elapses without receiving data indicating a confirmation of the particular candidate transcription of the second audio stream.

47. The system of claim 43, wherein providing the particular candidate transcription of the second audio stream, or a result of a search query in which the particular candidate transcription of the second audio stream is used as a query term, for output comprises presenting a confirmation control.

48. (canceled)

49. The system of claim 43, wherein providing the particular candidate transcription of the second audio stream, or a result of a search query in which the particular candidate transcription of the second audio stream is used as a query term, for output comprises providing a web site corresponding to a highest ranked search query result for output based on a search query performed using the particular candidate transcription of the second audio stream.

50. The system of claim 43, wherein providing the particular candidate transcription of the second audio stream, or a result of a search query in which the particular candidate transcription of the second audio stream is used as a query term, for output comprises providing a web site corresponding to a previously selected web site from a search query result based on a search query performed using the particular candidate transcription of the first audio stream.

51. The system of claim 43, wherein providing the particular candidate transcription of the second audio stream, or a result of a search query in which the particular candidate transcription of the second audio stream is used as a query term, for output comprises:
determining, based on a confidence level associated with the match between (i) the particular candidate transcription of the second audio stream and the particular candidate transcription of the first audio stream indicated in the stored data that pairs the particular candidate transcription of the first audio stream and the first audio stream, or (ii) the second audio stream and the first audio stream indicated in the stored data that pairs the particular candidate transcription of the first audio stream and the first audio stream, whether to display (i) a confirmation request, (ii) a list of search query results based on a search query performed using the particular candidate transcription of the second audio stream, (iii) a web site corresponding to a top-rated search query result based on a search query performed using the particular candidate transcription of the second audio stream, or (iv) a web site corresponding to a previously selected web site from a search query result based on a search query performed using the particular candidate transcription of the first audio stream.

52. A non-transitory computer-readable device storing software comprising instructions executable by one or more computers which, upon such execution, cause the one or more computers to perform operations comprising:
receiving a first audio stream corresponding to a first voice command;
providing one or more candidate transcriptions of the first audio stream for output;
receiving data indicating a selection of a result of a search query in which a particular candidate transcription of the first audio stream was used as a query term;
in response to receiving the data indicating the selection of the result of the search query in which the particular candidate transcription is used as a query term, storing data that pairs (i) the particular candidate transcription of the first audio stream, and (ii) the first audio stream;
after storing the data that pairs the particular candidate transcription of the first audio stream and the first audio stream, receiving a second audio stream corresponding to a second voice command;
comparing (i) a particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream;
based at least on comparing (i) the particular candidate transcription of the second audio stream to the particular candidate transcription of the first audio stream indicated in the stored data that pairs the particular candidate transcription of the first audio stream and the first audio stream, or (ii) the second audio stream to the first audio stream indicated in the stored data that pairs the particular candidate transcription of the first audio stream and the first audio stream, determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream; and
based at least on determining that (i) the particular candidate transcription of the second audio stream matches the particular candidate transcription of the first audio stream indicated in the stored data that pairs the particular candidate transcription of the first audio stream and the first audio stream, or that (ii) the second audio stream matches the first audio stream indicated in the stored data that pairs the particular candidate transcription of the first audio stream and the first audio stream, providing the particular candidate transcription of the second audio stream, or a result of a search query in which the particular candidate transcription of the second audio stream is used as a query term, for output.

53. The non-transitory computer-readable device of claim 52, further comprising providing one or more other candidate transcriptions of the second audio stream for output after receiving data indicating a rejection of the particular candidate transcription of the second audio stream or after a predetermined amount of time elapses without receiving data indicating a confirmation of the particular candidate transcription of the second audio stream.

54. The method of claim 1, wherein providing the particular candidate transcription of the second audio stream, or a result of a search query in which the particular candidate transcription of the second audio stream is used as a query term, for output comprises:
determining that the second audio stream matches the first audio stream indicated in the stored data that pairs the particular candidate transcription of the first audio stream and the first audio stream; and
providing the particular transcription of the second audio stream, or a result of a search query in which the particular candidate transcription of the second audio stream is used as a query term, for output before performing any speech recognition on the second audio stream.

55-56. (canceled)
